(19) United States
(12) Patent Application Publication
(10) Pub. No.: US 2026/0065900 A1
(43) Pub. Date: Mar. 5, 2026

(54) INTENT INFERENCE IN AUDIOVISUAL COMMUNICATION SESSIONS

(71) Applicant: Sonos, Inc., Goleta, CA (US)

(72) Inventor: Paul Bates, Seattle, WA (US)

(21) Appl. No.: 19/081,966

(22) Filed: Mar. 17, 2025

Related U.S. Application Data
(63) Continuation of application No. 17/450,925, filed on Oct. 14, 2021, now Pat. No. 12,283,269.
(60) Provisional application No. 63/092,686, filed on Oct. 16, 2020.

(51) Int. Cl. G10L 15/05; G10L 15/07; G10L 15/22; H04L 12/18

(52) U.S. Cl. CPC G10L 15/05; G10L 15/07; G10L 15/22; H04L 12/1818; H04L 12/1831; G10L 2015/223

(57) ABSTRACT

In one aspect, a user's intent can be inferred based on voice analysis during a communications session, and prompts can be presented, or other actions taken, at least partly in response to the inferred intent. For example, a network microphone device (NMD) having one or more microphones can capture voice input and transmit the voice input to remote computing device(s) for a communication session (e.g., a videoconference). The NMD can analyze the voice input to detect one or more utterances. Based on the utterance(s), the NMD can cause a user prompt to be displayed via a display device communicatively coupled to the NMD. The particular prompt can depend at least in part on one or more context parameters associated with the communication session (e.g., a microphone state of one or more users, a screen share state of one or more users, or a recording status of the session, etc.).

### CROSS-REFERENCE TO RELATED APPLICATIONS

This application is a continuation of U.S. patent application Ser. No. 17/450,925, filed Oct. 14, 2021, which claims the benefit of priority to U.S. Patent Application No. 63/092,686, filed Oct. 16, 2020, each of which incorporated herein by reference in its entirety.

### FIELD OF THE DISCLOSURE

The present technology relates to consumer goods and, more particularly, to methods, systems, products, features, services, and other elements directed to audiovisual communications systems or some aspect thereof.

### BACKGROUND

Computer-mediated audiovisual communication is increasingly commonplace. In many cases, two or more participants may communicate with one another using a plurality of audiovisual communication devices. Each audiovisual communication device can be equipped to receive input from a local user (e.g., microphones to capture voice input, a camera to capture the user's image) and to provide output received from one or more remote participants (e.g., speakers to output the other participants' voice input, a screen to display the remote participants' images, etc.). Such audiovisual communication systems can be usefully employed for video conferencing, webinars, real-time streaming of entertainment content (e.g., streaming of e-gaming performances), or other such applications.

### BRIEF DESCRIPTION OF THE DRA WINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

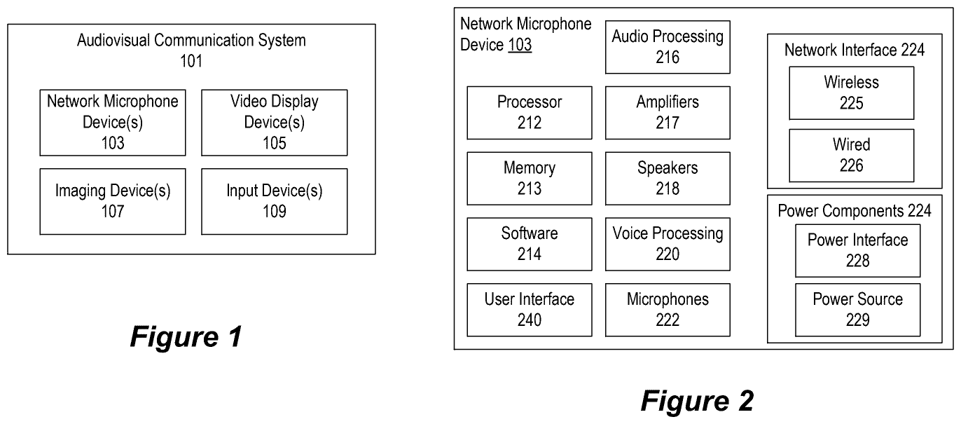

FIG. 1 is a functional block diagram of an example audiovisual communication system.

FIG. 2 is a functional block diagram of an example network microphone device.

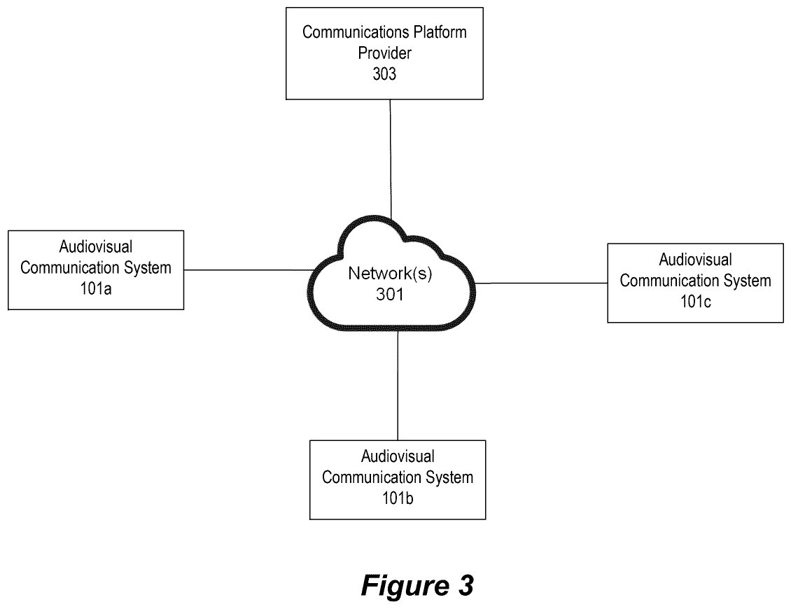

FIG. 3 is a schematic diagram of a plurality of audiovisual communication systems in communication with a communications platform provider via one or more networks.

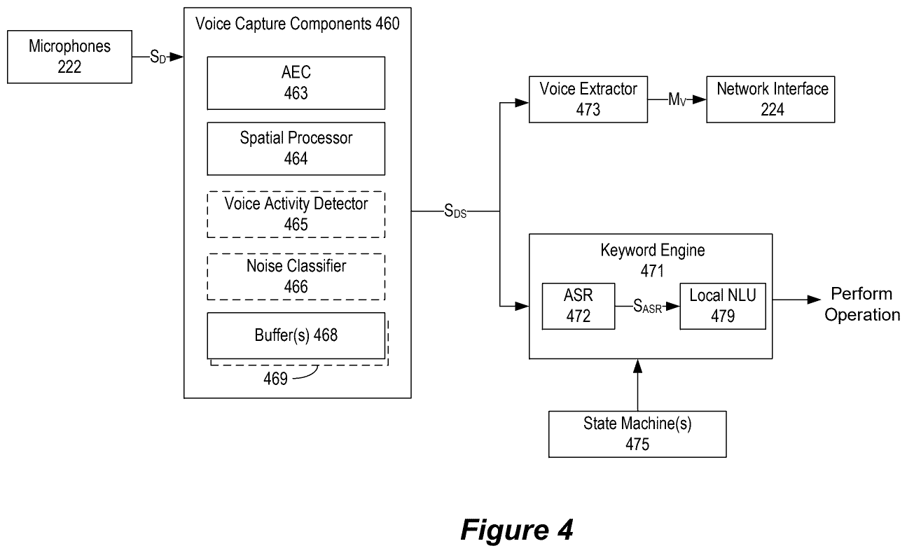

FIG. 4 is a functional block diagram of certain components of an example network microphone device in accordance with aspects of the disclosure.

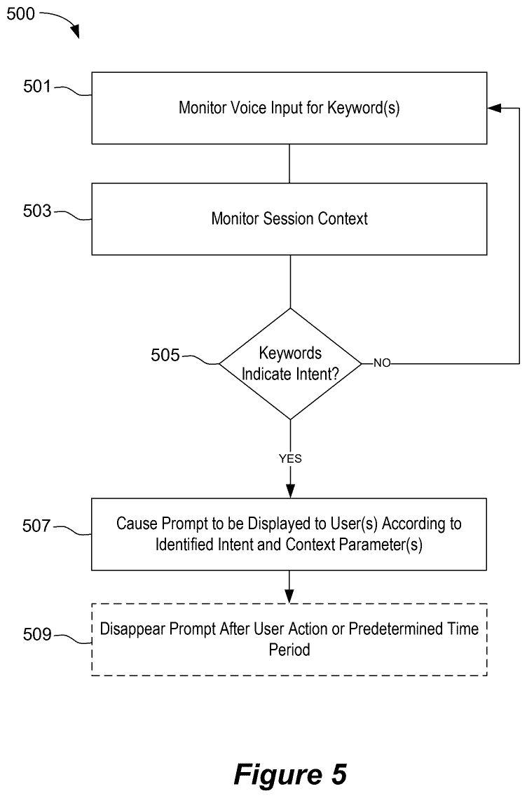

FIG. 5 is a flow diagram of another example method for intent inference in audiovisual communication sessions in accordance with aspects of the disclosure.

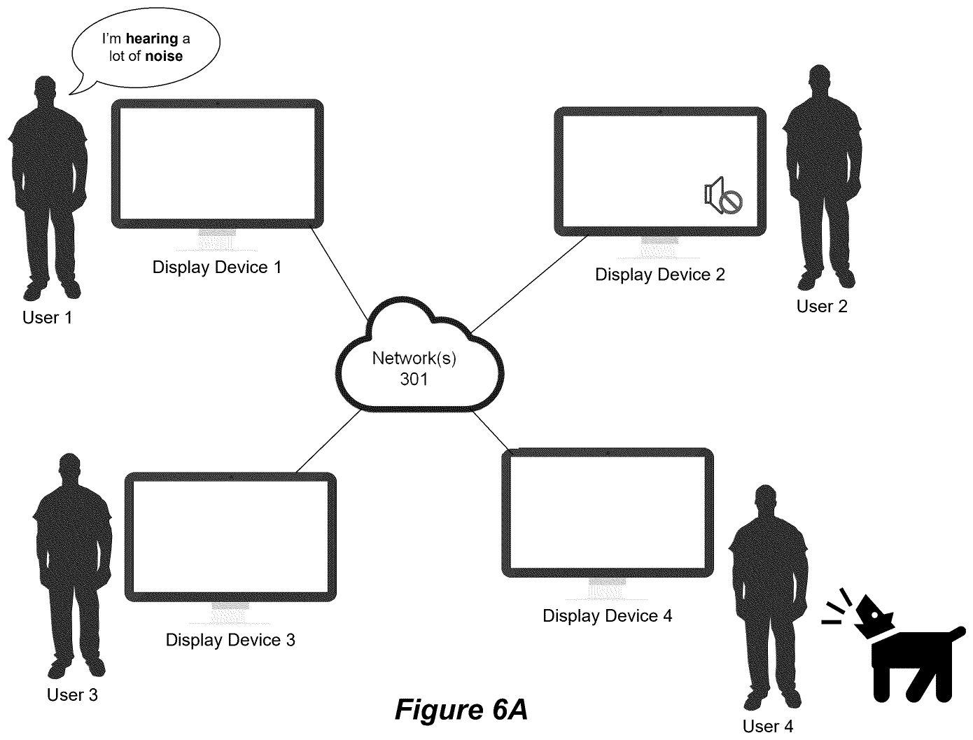

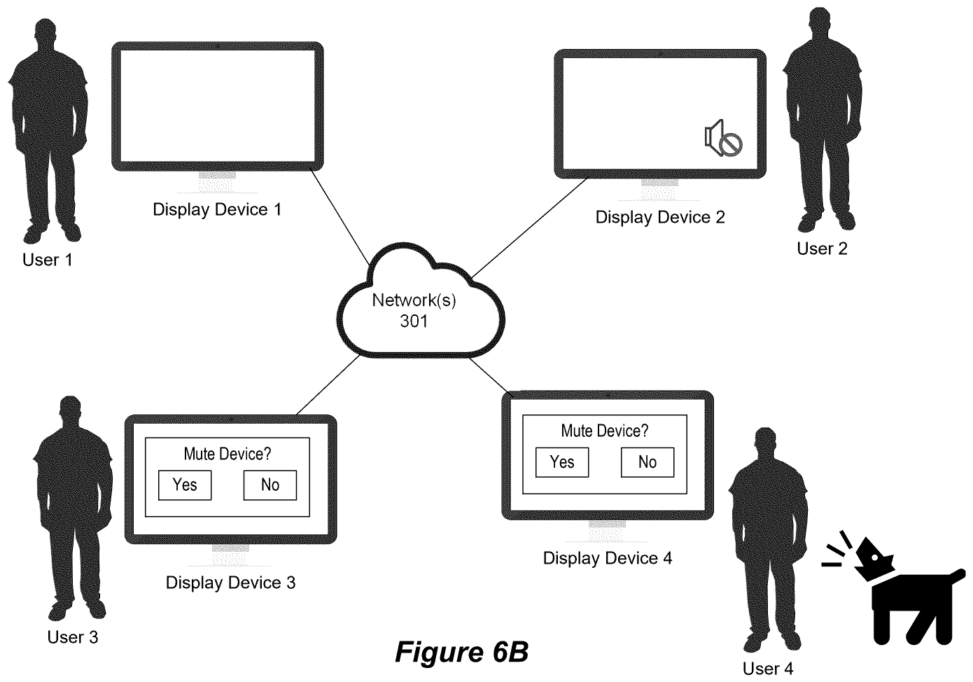

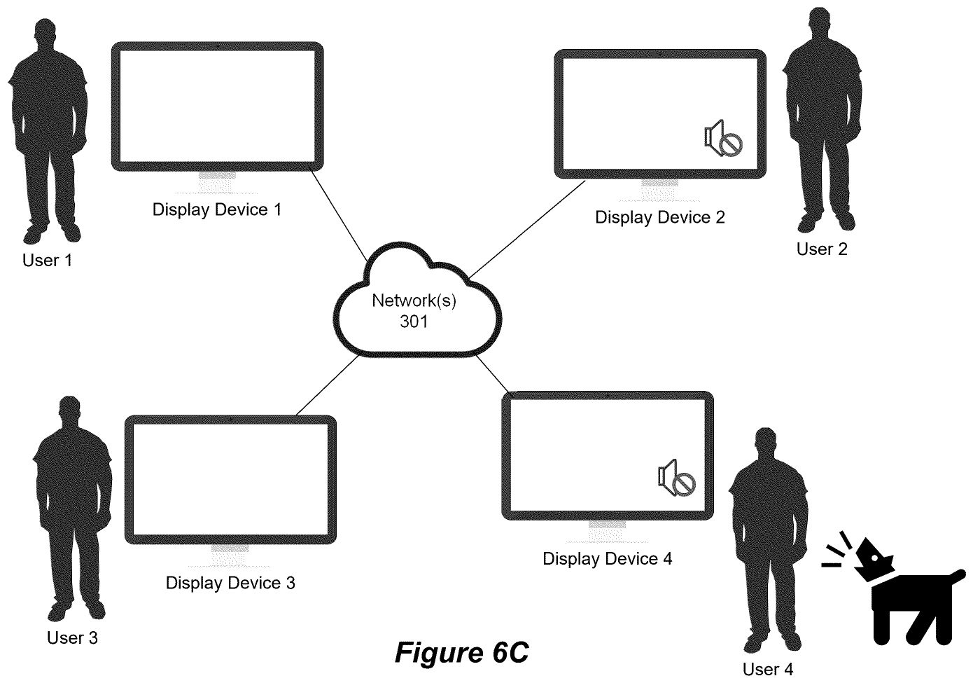

FIGS. 6A-6C illustrates an example of intent inference in an audiovisual communication session in accordance with aspects of the disclosure.

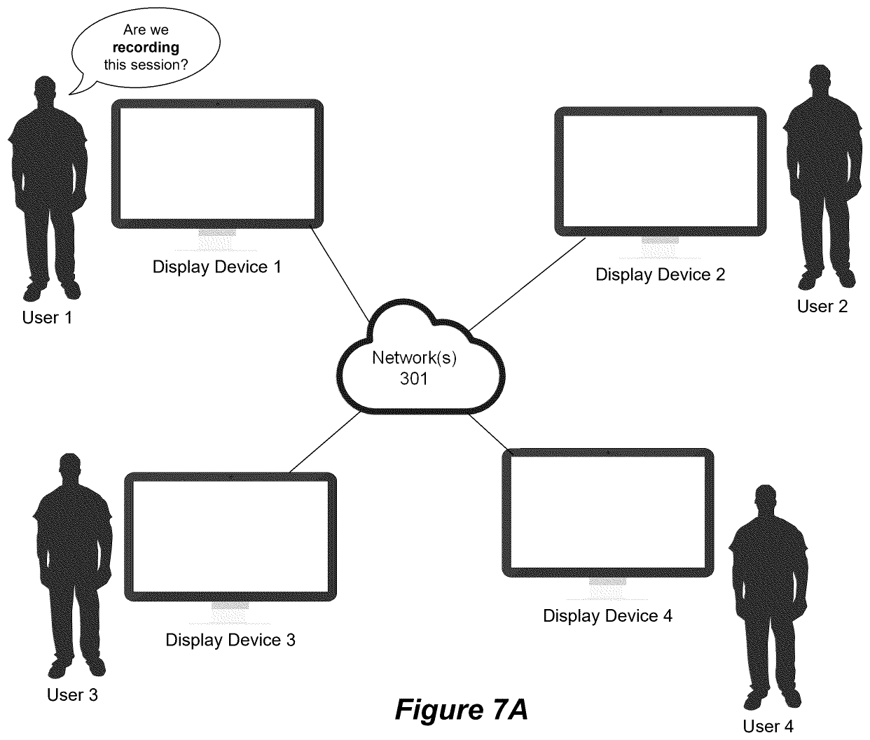

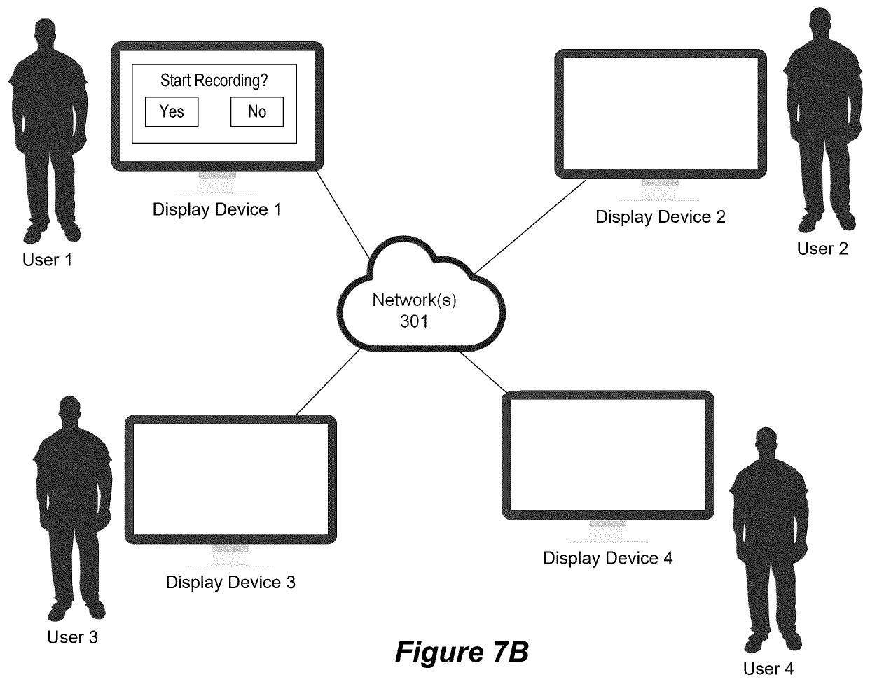

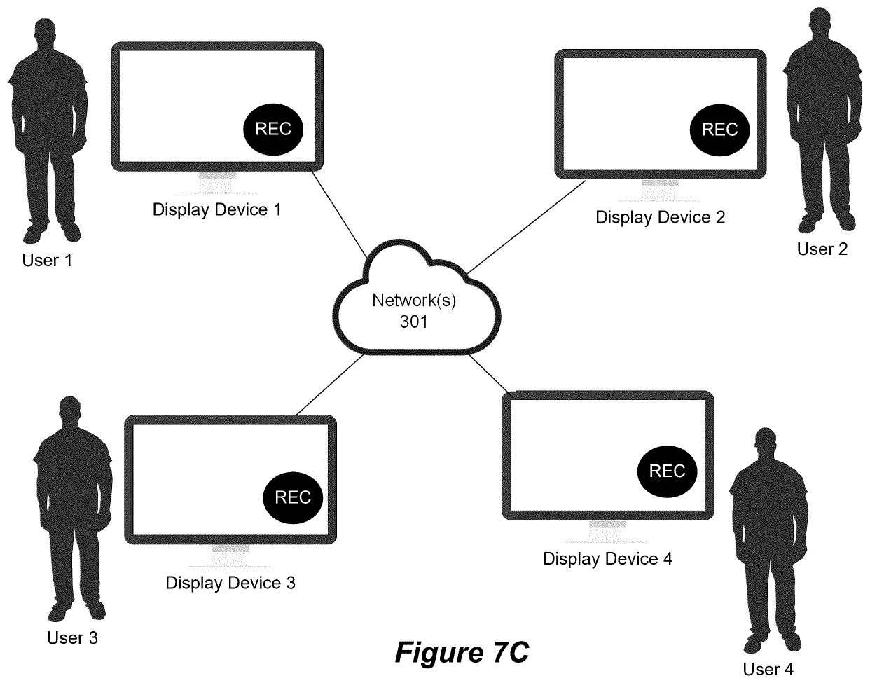

FIG. 7A-7C illustrates another example of intent inference in an audiovisual communication session in accordance with aspects of the disclosure.

The drawings are for purposes of illustrating example embodiments, but it should be understood that the inventions are not limited to the arrangements and instrumentality shown in the drawings. In the drawings, identical reference numbers identify at least generally similar elements. To facilitate the discussion of any particular element, the most significant digit or digits of any reference number refers to the Figure in which that element is first introduced. For example, element 103 is first introduced and discussed with reference to FIG. 1.

### DETAILED DESCRIPTION

### I. Overview

Example techniques described herein involve monitoring voice input during audiovisual communication sessions for keywords and context parameters. Based on identified keywords and/or context parameters, one or more actions can be taken to facilitate or improve the communication session. In some instances, an audiovisual communication system (ACS) can be a network microphone device (NMD) having one or more microphones configured to detect voice input and one or more audio transducers configured to provide audio output. The ACS can also include a video display device (e.g., a screen, projector, etc.), an imaging device (e.g., a camera), and one or more additional input devices (e.g., a keyboard, touchscreen, etc.). In various embodiments, some or all of the devices can be integrated together into a common device or housing, such as a laptop, tablet, smartphone, etc. Additionally or alternatively, one or more of the constituent devices of the ACS can be a standalone device that is wired or wirelessly coupled to the other devices. For example, a standalone NMD can be wired or wirelessly coupled to a video display device, imaging device, and/or any other input devices.

Such ACSs can be used to facilitate communication among two or more remote participants. For example, a first ACS can capture a first participant's voice input (via an NMD) and video image (via an imaging device) and transmit this data over a network to a second ACS, where the first participant's voice input and video image can be output to a second user (e.g., via an NMD and a video display device, respectively). Such communication can be bidirectional, allowing each participant to both provide and receive voice and/or audio input. Additionally, in some embodiments this communication can include features such as screen sharing (e.g., allowing a first user to broadcast some or all of the user's device screen to one or more remote participants), text communication (e.g., allowing users to send and receive text via a chat interface or other format), or other such additional features as are known to one of ordinary skill in the art.

Depending on the particular context, participants may wish to vary operation of one or more of the ACSs in use during a communication session. For example, one or more of the ACSs may be muted or unmuted, the session may be recorded for later viewing or distribution, a participant may share a screen, one or more users can be granted “host” status or have “host” status removed, one or more users can be granted control of another user's screen, etc. Conventionally, each participant can perform actions associated with these operations via a graphical user interface (e.g., mouse and keyboard or touchscreen navigation of control menus associated with a software program). However, such navigation may be unduly complicated, and some participants may be unfamiliar with the available control options. Additionally, in some instances it can be beneficial to prompt a user to take action that the user otherwise may not perform. For example, a user who mistakenly believes her microphone to be muted can be prompted to mute her microphone.

In various embodiments, an NMD of an audiovisual communication system can monitor voice input during a communication session to detect one or more utterances. For example, an NMD can include a keyword engine configured to process voice input captured via microphones of the NMD or voice input received from one or more remote computing devices, and to detect one or more particular utterances in the voice input. The utterances can be used to infer a user intent, which in turn can cause the ACS to provide a user prompt offering a participant the option to perform an action. The prompt can be, for example, a visual prompt displayed via a display device of the same or a different ACS. As one example, in response to an NMD detecting a user utterance “are we recording this session?” in the voice input, the NMD can cause a user prompt to be displayed giving the user, or the user holding the permission to record, the option of initiating recording of the session. In some embodiments, such a user prompt can be removed (e.g., disappeared from the display device) once a user makes a selection or after a predetermined period of time has elapsed (e.g., 10 seconds, 30 seconds).

In some embodiments, NMD can also monitor one or more context parameters associated with the communication session, which can be used in combination with detection of a voice utterance to infer intent and/or determine an action to be taken by the NMD. For example, the context parameters can include a microphone state of one or more participants (e.g., muted or unmuted), a screen share state of one or more participants (e.g., whether a participant's screen is currently being shared with other participants), a recording status of the session (e.g., whether the session is being recorded), or a participant role (e.g., host or non-host). Various other context parameters can be detected or received via the NMD and used in combination with detected voice utterance(s) to infer a user intent and surface an appropriate prompt.

In certain instances, a user prompt may be displayed to some but not all participants in a particular communication session. For example, a user prompt asking whether a user wishes to mute the user's microphone may be presented only to those users whose ACSs are currently in an unmuted state. As another example, a user prompt asking whether a user wishes to mute a user's microphone may not be presented to a session host, but may be presented to non-host participants.

As noted above, an NMD (whether as a standalone device or integrated with one or more other devices of an audiovisual communication system) can be used to process voice input and identify an utterance. In some instances, an utterance can be processed to identify one or more keywords, for example using a keyword engine onboard the NMD. The keyword engine may be configured to identify (i.e., “spot” or “detect”) a particular keyword in recorded audio using one or more identification algorithms. As used herein, “keyword” can include full or partial words, phrases, or combinations of multiple discrete words or phrases within a voice utterance. Keyword identification algorithms may include pattern recognition trained to detect the frequency and/or time domain patterns that speaking a particular keyword creates. This keyword identification process is commonly referred to as “keyword spotting.” In practice, to help facilitate keyword spotting, the NMD may buffer sound detected by a microphone of the NMD and then use the keyword engine to process that buffered sound to determine whether a keyword is present in the recorded audio.

Additionally or alternatively, an NMD may include a local natural language unit (NLU). As used herein, an NLU can be an onboard natural language understanding processor, or any other component or combination of components configured to recognize language in sound input data. In contrast to an NLU implemented in one or more cloud servers that is capable of recognizing a wide variety of voice inputs, example local NLUs may be capable of recognizing a relatively small library of keywords (e.g., approximately 10,000 intents, words and/or phrases), which facilitates practical implementation on the NMD. In some embodiments, the local NLU may process the voice input to look for keywords from the library and determine an intent from the found keywords. Such an inferred intent can then be used to cause appropriate user prompts to be displayed to one or more participants of an audiovisual communication session.

While some embodiments described herein may refer to functions performed by given actors, such as “users” and/or other entities, it should be understood that this description is for purposes of explanation only. The claims should not be interpreted to require action by any such example actor unless explicitly required by the language of the claims themselves.

Moreover, some functions are described herein as being performed “based on” or “in response to” another element or function. “Based on” should be understood that one element or function is related to another function or element. “In response to” should be understood that one element or function is a necessary result of another function or element. For the sake of brevity, functions are generally described as being based on another function when a functional link exists; however, such disclosure should be understood as disclosing either type of functional relationship.

### II. Example Operation Environment

FIG. 1 illustrates a functional block diagram of an audiovisual communication system (ACS) 101. The ACS 101 can be used by one or more participants to facilitate remote audiovisual communication with other participants. For example, a communication session can include a plurality of ACSs 101 that are located remotely from one another, with one or more participants at each ACS 101 able to provide audio and/or visual input to other participants and to receive audio and/or visual output from other participants. Examples of such communication sessions include videoconferences, webinars, streaming performances with audience or participant interactions (e.g., livestreams, real-time e-gaming, etc.), and any other such communication session that involves audio and/or visual content. In various embodiments, the communication sessions include both audio content (e.g., voice, music, etc.) and visual content (e.g., video feed from a participant's camera, screen sharing, other visual media content).

As shown, the ACS 101 can include one or more network microphone devices 103, one or more video display devices 105, one or more imaging devices 107, and one or more input devices 109. In various embodiments, some or all of the NMD 103, video display device(s) 105, imaging device(s) 107, and/or the input device(s) 109 may be integrated together into a single device (e.g., enclosed within a common housing or otherwise integrally formed). Such integrally formed ACSs can take the form of, for example, tablets, laptops, smartphones, all-in-one desktop computers, or other such assemblies. Additionally or alternatively, some or all of the constituent devices of the ACS 101 may be coupled to one another via point-to-point connections (e.g., Bluetooth) and/or over other connections, which may be wired and/or wireless, via a network, such as a local area network (LAN) which may include a network router. As used herein, a local area network can include any communications technology that is not configured for wide area communications, for example, WiFi, Bluetooth, Digital Enhanced Cordless Telecommunications (DECT), Ultra-WideBand, etc.

In operation, the NMD 103 can include one or more microphones configured to capture voice input from one or more users, and one or more audio transducers (e.g., speakers) configured to provide audio output. As discussed in more detail below with respect to FIG. 2, the NMD 103 can also include voice processing components configured to monitor and analyze audio content to detect speech utterances and, based at least in part on the detected utterances, infer a user intent.

The video display device(s) 105 can include any structure capable of providing visible output to a user. Examples include display screens (e.g., LCD, OLED, etc.), projectors, wearable displays (e.g., smartglasses or other heads-up displays), etc. In operation, the video display device(s) 105 can provide visual output to a user of the ACS 101, such as video feed of another participant in a communication session, a user interface for controlling operation of the ACS 101, or other such visual output. As described in more detail below, in some examples user prompts can be presented to a user via the video display device(s) 105, for example a user prompt to mute or unmute a microphone, to share or un-share a screen, to record a session, or any other suitable user prompt.

The imaging device(s) 107 can include any device capable of capturing still or moving images for transmission to other participants in a communication session. Examples include a webcam integrated into another computing device (e.g., a laptop, tablet, or smartphone), a standalone camera, or any other suitable instrument. In various examples, there may be multiple different imaging devices that operate in concert (e.g., simultaneously to present multiple views at once, or sequentially to toggle between various views), or in other instances the ACS 101 may include no imaging device whatsoever. In such instances, a user of the ACS 101 may nonetheless be able to participate in an audiovisual communication session, even if no image data is generated via an imaging device 107. In operation, image data captured via the imaging device(s) 107 can be transmitted over a network to be presented to remote participants in the communication session. Such image data can be played back via a remote ACS 101 (e.g., via its video display device 105) concurrently or synchronously with playback of any audio captured via the NMD 103 and transmitted to the remote ACS 101. In some embodiments, image data captured via the imaging device(s) 107 can be analyzed (e.g., using facial recognition algorithms, machine-learning algorithms, or any suitable image-processing techniques) to detect user behavior, orientation, or status. For example, image data can be analyzed to detect that a user is speaking or attempting to speak, to detect that a user has turned away from the imaging devices 107 or left the field of view altogether, that a user has fallen asleep, that a user has made a particular gesture or movement, etc.

The ACS 101 optionally includes one or more additional input devices 109, which can take the form of a keyboard, mouse, touchscreen (e.g., a display screen with an integrated capacitive touch sensor), buttons, dials, knobs, or any other suitable input device. In operation, a user may control operation of the ACS 101 via the input device(s) 109, for example starting, joining, leaving, or ending particular communication sessions, muting or unmuting microphones, turning the imaging device(s) 107 on or off, initiating or ceasing screen sharing, or any other such control operation.

Further aspects relating to the different components of the example ACS 101 and how the different components may interact to provide a user with an audiovisual communication experience may be found in the following sections. While discussions herein may generally refer to the example ACS 101, technologies described herein are not limited to applications within, among other things, the environment described above. For instance, the technologies described herein may be useful in other configurations comprising more or fewer of any of the NMD 103, video display device(s) 105, imaging device(s) 107, or input device(s) 109. For example, the technologies herein may be utilized during audio-only communication sessions, with user prompts taking the form of audible cues or other suitable user prompts.

a. Example Network Microphone Devices

FIG. 2 is a functional block diagram illustrating certain aspects of one of the NMDs 103 shown in FIG. 1. As shown, the NMD 103 includes various components, each of which is discussed in further detail below, and the various components of the NMD 103 may be operably coupled to one another via a system bus, communication network, or some other connection mechanism.

As shown, the NMD 103 includes at least one processor 212, which may be a clock-driven computing component configured to process input data according to instructions stored in memory 213. The memory 213 may be a tangible, non-transitory, computer-readable medium configured to store instructions that are executable by the processor 212. For example, the memory 213 may be data storage that can be loaded with software code 214 that is executable by the processor 212 to achieve certain functions.

In one example, these functions may involve the NMD 103 retrieving audio data from an audio source, which may be another NMD or one or more remote computing devices. In another example, the functions may involve the NMD 103 sending audio data, detected-sound data (e.g., corresponding to a voice input), and/or other information to another device on a network via at least one network interface 224. Numerous other example functions are possible, some of which are discussed below.

To facilitate audio playback, the NMD 103 includes audio processing components 216 that are generally configured to process audio prior to the NMD 103 rendering the audio. In this respect, the audio processing components 216 may include one or more digital-to-analog converters (“DAC”), one or more audio preprocessing components, one or more audio enhancement components, one or more digital signal processors (“DSPs”), and so on. In some implementations, one or more of the audio processing components 216 may be a subcomponent of the processor 212. In operation, the audio processing components 216 receive analog and/or digital audio and process and/or otherwise intentionally alter the audio to produce audio signals for playback.

The produced audio signals may then be provided to one or more audio amplifiers 217 for amplification and playback through one or more speakers 218 operably coupled to the amplifiers 217. The audio amplifiers 217 may include components configured to amplify audio signals to a level for driving one or more of the speakers 218.

Each of the speakers 218 may include an individual transducer (e.g., a “driver”) or the speakers 218 may include a complete speaker system involving an enclosure with one or more drivers. A particular driver of a speaker 218 may include, for example, a subwoofer (e.g., for low frequencies), a mid-range driver (e.g., for middle frequencies), and/or a tweeter (e.g., for high frequencies). In some cases, a transducer may be driven by an individual corresponding audio amplifier of the audio amplifiers 217. In some implementations, an NMD may not include the speakers 218, but instead may include a speaker interface for connecting the NMD to external speakers. In certain embodiments, an NMD may include neither the speakers 218 nor the audio amplifiers 217, but instead may include an audio interface (not shown) for connecting the NMD to an external audio amplifier or audio-visual receiver.

As shown, the at least one network interface 224, may take the form of one or more wireless interfaces 225 and/or one or more wired interfaces 226. A wireless interface may provide network interface functions for the NMD 103 to wirelessly communicate with other devices (e.g., other playback device(s), NMD(s), and/or controller device(s)) in accordance with a communication protocol (e.g., any wireless standard including IEEE 802.11a, 802.11b, 802.11 g, 802.11n, 802.11ac, 802.15, 4G or 5G mobile communication standards, and so on). A wired interface may provide network interface functions for the NMD 103 to communicate over a wired connection with other devices in accordance with a communication protocol (e.g., IEEE 802.3). While the network interface 224 shown in FIG. 2 include both wired and wireless interfaces, the NMD 103 may in some implementations include only wireless interface(s) or only wired interface(s).

In general, the network interface 224 facilitates data flow between the NMD 103 and one or more other devices on a data network. For instance, the NMD 103 may be configured to receive audio content over the data network from one or more other devices, network devices within a LAN, and/or audio content sources over a WAN, such as the Internet. In one example, the audio content and other signals transmitted and received by the NMD 103 may be transmitted in the form of digital packet data comprising an Internet Protocol (IP)-based source address and IP-based destination addresses. In such a case, the network interface 224 may be configured to parse the digital packet data such that the data destined for the NMD 103 is properly received and processed by the NMD 103.

As shown in FIG. 2, the NMD 103 also includes voice processing components 220 that are operably coupled to one or more microphones 222. The microphones 222 are configured to detect sound (i.e., acoustic waves) in the environment of the NMD 103, which is then provided to the voice processing components 220. More specifically, each microphone 222 is configured to detect sound and convert the sound into a digital or analog signal representative of the detected sound, which can then cause the voice processing component 220 to perform various functions based on the detected sound, as described in greater detail below. In one implementation, the microphones 222 are arranged as an array of microphones (e.g., an array of six microphones). In some implementations, the NMD 103 includes more than six microphones (e.g., eight microphones or twelve microphones) or fewer than six microphones (e.g., four microphones, two microphones, or a single microphones).

In operation, the voice-processing components 220 are generally configured to detect and process sound received via the microphones 222, identify potential voice input in the detected sound, and extract detected-sound data to enable a keyword engine (FIG. 4), to process voice input identified in the detected-sound data. The voice processing components 220 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more keyword engines, one or more voice extractors, and/or one or more speech processing components (e.g., components configured to recognize a voice of a particular user or a particular set of users associated with a household), among other example voice processing components. In example implementations, the voice processing components 220 may include or otherwise take the form of one or more DSPs or one or more modules of a DSP. In this respect, certain voice processing components 220 may be configured with particular parameters (e.g., gain and/or spectral parameters) that may be modified or otherwise tuned to achieve particular functions. In some implementations, one or more of the voice processing components 220 may be a subcomponent of the processor 212.

As further shown in FIG. 2, the NMD 103 also includes power components 227. The power components 227 include at least an external power source interface 228, which may be coupled to a power source (not shown) via a power cable or the like that physically connects the NMD 103 to an electrical outlet or some other external power source. Other power components may include, for example, transformers, converters, and like components configured to format electrical power.

In some implementations, the power components 227 of the NMD 103 may additionally include an internal power source 229 (e.g., one or more batteries) configured to power the NMD 103 without a physical connection to an external power source. When equipped with the internal power source 229, the NMD 103 may operate independent of an external power source. In some such implementations, the external power source interface 228 may be configured to facilitate charging the internal power source 229. An NMD comprising an internal power source may be referred to herein as a “portable NMD.” On the other hand, an NMD that operates using an external power source may be referred to herein as a “stationary NMD,” although such a device may in fact be moved around a home or other environment.

The NMD 103 further includes a user interface 240 that may facilitate user interactions. In various embodiments, the user interface 240 includes one or more physical buttons and/or supports graphical interfaces provided on touch sensitive screen(s) and/or surface(s), among other possibilities, for a user to directly provide input. The user interface 240 may further include one or more of lights (e.g., LEDs) and the speakers to provide visual and/or audio feedback to a user.

In operation, the NMD 103 can capture and process voice input. The voice input may include a user utterance, which may or may not include one or more keywords. In various implementations, an underlying intent can be determined based on the words in the utterance.

Based on certain criteria, the NMD and/or the audiovisual communication system 101 may take actions as a result of identifying one or more user intents based on utterance(s) in the voice input. The user intent may be based on the inclusion of certain keywords within the voice input, among other possibilities. Additionally, or alternatively, determining or inferring the user intent may involve identification of one or more state variables in conjunction with identification of one or more particular operations. Such state variables may include, for example, indicators identifying a microphone status of a device (e.g., muted or unmuted), a level of volume, participant status (e.g., host vs. non-host), whether a screen or other content is being shared, whether a communication session is being recorded, etc.

ASR for keyword detection may be tuned to accommodate a wide range of keywords (e.g., 5, 10, 100, 1,000, 10,000 keywords). Such keyword detection may involve feeding ASR output to an onboard, local NLU which together with the ASR determine when keyword events have occurred. In some implementations described below, a keyword engine may determine an intent based on one or more other keywords in the ASR output produced by a particular voice input. In these or other implementations, an NMD's actions in response to the detected keyword even may depend at least in part on certain context parameters (e.g., device state, user status, etc.).

b. Example Communication Session Environments

FIG. 2 is a schematic diagram illustrating an environment in which an audiovisual communication session can be carried out. As shown in FIG. 3, a plurality of discrete ACSs 101a, 101b, and 101c (collectively “ACSs 101”) can communicate with one another remotely via one or more telecommunications network(s) 301. The network(s) 301 can include any suitable wide area network such as the Internet, cellular communications network (e.g., an LTE network, a 5G network, etc.), or any other suitable communications network, whether wired, wireless, or some combination thereof.

A communications platform provider (CPP) 303 is also communicatively coupled to the ACSs 101 via the network(s) 301. The CPP 303 can include one or more remote computing devices (e.g., cloud servers) associated with a communications platform. Examples of such communications platforms include MICROSOFT TEAMS, ZOOM, CISCO WEBEX, GOTOMEETING, TWITCH, FACEBOOK LIVE, or other such platforms. The examples are illustrative only, and in various embodiments the particular CPP can take a variety of forms and provide various different functions and capabilities. In operation, each ACS 101 can receive user input (e.g., voice input, a video feed from a user's webcam) and transmit the input to other ACSs 101 for output to other users. In some instances, the CPP 303 can serve as an intermediary and coordinator for such transmission of data between the various ACSs 101. For example, in the case of a videoconference, each user's audio data (as captured by the NMD 103 of that particular ACS) can be transmitted, via the network(s) 301, to the CPP 303, which then processes and transmits the audio data to each of the other ACSs 101 that are participating in that particular videoconference.

In at least some embodiments, one or more of the ACSs 101 involved in the communication session may lack certain components described above. For example, one ACS 101 may include audio input and output components (e.g., microphone(s) and speaker(s)) but may not include a video display device. Similarly, one ACS 101 may include a video display device but may not include audio output components (e.g., speaker(s)). In various embodiments, any given ACS 101 can exclude any combination of the components described above with respect to FIGS. 1 and 2.

### III. Example Keyword Detection in Voice Input

With continued reference to FIG. 3, during communication sessions among multiple ACSs 101, participants may wish to vary operation of one or more of the ACSs 101. For example, one or more of the ACSs 101 may be muted or unmuted, the session may be recorded for later viewing or distribution, a participant may share a screen or other content, one or more users can be granted “host” status or have “host” status removed, one or more participants can be granted control of another participant's screen, etc. Conventionally, each participant can perform actions associated with these operations via a graphical user interface associated with that participant's ACS 101 (e.g., mouse and keyboard or touchscreen navigation of control menus associated with a videoconferencing software program). However, such navigation may be unduly complex, and some participants may be unfamiliar with the available control options. Additionally, in some instances it can be beneficial to prompt a user to take action that the user otherwise may not perform. For example, a user who mistakenly believes her microphone to be muted can be prompted to mute her microphone.

In various embodiments, an NMD of some or all of the ACSs 101 can monitor voice input during a communication session to detect one or more utterances. As noted above, such an NMD can include a natural language unit (NLU) configured to process voice input captured via microphones of the NMD or voice input received from one or more remote computing devices (e.g., from one or more other ACSs 101), and to detect one or more particular utterances in the voice input. The utterances can be used to infer a user intent, which in turn can cause the ACS 101 to provide a user prompt offering a participant the option to perform an action. In some embodiments, a user prompt that has been presented in response to detection of a voice utterance can be removed (e.g., disappeared from the display device) once a user makes a selection or after a predetermined period of time has elapsed (e.g., 10 seconds, 30 seconds).

The particular prompt and associated action can relate to any function of the ACS 101 or any aspect of the communication session. As one example, if the first ACS 101a detects an utterance in the voice input that says “can everyone please mute their microphones?,” the ACS 101a can cause a user prompt to be displayed on each of the other ACSs 101b and 101c that offers the participant the option to mute her microphone. The prompt can be, for example, a visual prompt displayed via a display device of ACSs 101b and 101c. As another example, in response to an NMD of the first ACS 101a detecting a user utterance “are we recording this session?” in the voice input, the ACS 101a can cause a user prompt to be displayed on a display device of the first ACS 101a giving the user the option of initiating recording of the session.

In each of these examples, the first ACS 101a (or one of its component devices, such as an NMD) can cause the user prompt to be displayed by transmitting a control signal to the CPP 303, which in turn causes the appropriate user prompt(s) to be displayed via display devices of the particular ACSs 101. Additionally or alternatively, the first ACS 101a can communicate directly with the other ACSs 101b or 101c in a manner that causes a user prompt to be presented, without the intermediation of the CPP 303.

As noted previously, some or all of the ACSs 101 can also monitor one or more context parameters associated with the communication session, which can be used in combination with detection of a voice utterance to infer intent and/or determine an action to be taken by the ACS 101. For example, the context parameters can include a microphone state of one or more participants (e.g., muted or unmuted), a screen share state of one or more participants (e.g., whether a participant's screen is currently being shared with other participants), a recording status of the session (e.g., whether the session is being recorded), or a participant role (e.g., host or non-host). Various other context parameters can be detected or received via the NMD and used in combination with detected voice utterance(s) (e.g., keywords) to infer a user intent and surface an appropriate prompt. In certain instances, a user prompt may be displayed to some but not all participants in a particular communication session. In some examples, a context parameter can include a user status as detected via analyzing image data captured via the corresponding imaging device 109 (e.g., a user moving her mouth, a user leaving the field of view or turning away, a user raising her hand, the direction of a user's gaze, etc.).

As discussed above, an ACS 101 can include an NMD 103 configured to capture and process voice input to detect utterance(s) that can be used to infer user intent. FIG. 4 is a functional block diagram showing aspects of an NMD 103 configured in accordance with embodiments of the disclosure. As described in more detail below, the NMD 103 is configured to process certain voice inputs locally (e.g., to detect utterances, optionally including one or more keywords therein, to infer a user intent), without necessarily transmitting data representing the voice input to remote computing devices for analysis or processing.

Referring to FIG. 4, the NMD 103 includes voice capture components (“VCC”) 460, a voice extractor 473, and a keyword engine 471. The voice extractor 473 and the keyword engine 471 are each operably coupled to the VCC 460. The NMD 103 further includes microphones 222 and the at least one network interface 224 as described above and may also include other components, such as audio amplifiers, a user interface, etc., which are not shown in FIG. 4 for purposes of clarity. The microphones 222 of the NMD 103 are configured to provide detected sound, S_{D}, from the environment of the NMD 103 to the VCC 460. The detected sound S_{D} may take the form of one or more analog or digital signals. In example implementations, the detected sound S_{D} may be composed of a plurality signals associated with respective channels that are fed to the VCC 460.

Each input channel may correspond to a particular microphone 222. For example, an NMD having six microphones may have six corresponding channels. Each channel of the detected sound S_{D} may bear certain similarities to the other channels but may differ in certain regards, which may be due to the position of the given channel's corresponding microphone relative to the microphones of other channels. For example, one or more of the channels of the detected sound S_{D} may have a greater signal to noise ratio (“SNR”) of speech to background noise than other channels.

As further shown in FIG. 4, the VCC 460 includes an AEC 463, a spatial processor 464, and one or more buffers 468. In operation, the AEC 463 receives the detected sound S_{D} and filters or otherwise processes the sound to suppress echoes and/or to otherwise improve the quality of the detected sound S_{D}. That processed sound may then be passed to the spatial processor 464.

The spatial processor 464 is typically configured to analyze the detected sound S_{D} and identify certain characteristics, such as a sound's amplitude (e.g., decibel level), frequency spectrum, directionality, etc. In one respect, the spatial processor 464 may help filter or suppress ambient noise in the detected sound S_{D} from potential user speech based on similarities and differences in the constituent channels of the detected sound S_{D}, as discussed above. As one possibility, the spatial processor 464 may monitor metrics that distinguish speech from other sounds. Such metrics can include, for example, energy within the speech band relative to background noise and entropy within the speech band-a measure of spectral structure-which is typically lower in speech than in most common background noise. In some implementations, the spatial processor 464 may be configured to determine a speech presence probability, examples of such functionality are disclosed in U.S. Patent Publication No. 2019/0355384, filed May 18, 2018, titled “Linear Filtering for Noise-Suppressed Speech Detection,” which is incorporated herein by reference in its entirety.

In operation, the one or more buffers 468—one or more of which may be part of or separate from the memory 213 (FIG. 2)—capture data corresponding to the detected sound S_{D}. More specifically, the one or more buffers 468 capture detected-sound data that was processed by the upstream AEC 464 and spatial processor 464.

The network interface 224 may then provide this information to a remote server for analysis. In one aspect, the information stored in the additional buffer 469 does not reveal the content of any speech but instead is indicative of certain unique features of the detected sound itself. In a related aspect, the information may be communicated between computing devices, such as the various ACSs 101, without necessarily implicating privacy concerns. In practice, this can be useful information to adapt and fine tune voice processing algorithms, including sensitivity tuning. In some implementations the additional buffer may comprise or include functionality similar to lookback buffers disclosed, for example, in U.S. Patent Publication No. 2019/0364375, filed May 25, 2018, titled “Determining and Adapting to Changes in Microphone Performance of Playback Devices”; U.S. Patent Publication No. 2020/0098372, filed Sep. 25, 2018, titled “Voice Detection Optimization Based on Selected Voice Assistant Service”; and U.S. Patent Publication No. 2020/0098386, filed Sep. 21, 2018, titled “Voice Detection Optimization Using Sound Metadata,” which are incorporated herein by reference in their entireties.

In any event, the detected-sound data forms a digital representation (i.e., sound-data stream), S_{DS}, of the sound detected by the microphones 222. In practice, the sound-data stream S_{DS} may take a variety of forms. As one possibility, the sound-data stream S_{DS} may be composed of frames, each of which may include one or more sound samples. The frames may be streamed (i.e., read out) from the one or more buffers 468 for further processing by downstream components, such as the keyword engine 471 and the voice extractor 473 of the NMD 103.

In some implementations, at least one buffer 468 captures detected-sound data utilizing a sliding window approach in which a given amount (i.e., a given window) of the most recently captured detected-sound data is retained in the at least one buffer 468 while older detected sound data is overwritten when it falls outside of the window. For example, at least one buffer 468 may temporarily retain 20 frames of a sound specimen at a given time, discard the oldest frame after an expiration time, and then capture a new frame, which is added to the 19 prior frames of the sound specimen.

In practice, when the sound-data stream S_{DS} is composed of frames, the frames may take a variety of forms having a variety of characteristics. As one possibility, the frames may take the form of audio frames that have a certain resolution (e.g., 16 bits of resolution), which may be based on a sampling rate (e.g., 44,100 Hz). Additionally, or alternatively, the frames may include information corresponding to a given sound specimen that the frames define, such as metadata that indicates frequency response, power input level, SNR, microphone channel identification, and/or other information of the given sound specimen, among other examples. Thus, in some embodiments, a frame may include a portion of sound (e.g., one or more samples of a given sound specimen) and metadata regarding the portion of sound. In other embodiments, a frame may only include a portion of sound (e.g., one or more samples of a given sound specimen) or metadata regarding a portion of sound.

In any case, downstream components of the NMD 103 may process the sound-data stream S_{DS}. For instance, the keyword engine 471 is configured to apply one or more identification algorithms to the sound-data stream S_{DS} (e.g., streamed sound frames) to spot potential keywords, phrases, or otherwise interpret and infer an intent in the detected-sound S_{D}. This process may be referred to as automatic speech recognition.

Example keyword detection algorithms accept audio as input and provide an indication of whether a keyword is present in the audio. Many first- and third-party keyword detection algorithms are known and commercially available. For instance, operators of a voice service may make their algorithm available for use in third-party devices. Alternatively, an algorithm may be trained to detect certain keywords.

In operation, the voice extractor 473 is configured to receive and format (e.g., packetize) the sound-data stream S_{DS}. For instance, the voice extractor 473 packetizes the frames of the sound-data stream S_{DS} into messages. The voice extractor 473 transmits or streams these messages, Mv, that may contain voice input in real time or near real time to remote computing devices (e.g., the CPP 303 of FIG. 3) via the network interface 224. When participating in a communication session, the messages can be transmitted via the network interface 224 to other participants for audio playback (e.g., to be played back via NMDs of other ACSs).

To determine the intent of the words, the keyword engine 471 can be in communication with one or more databases associated with the NMD 103 and/or one or more databases stored via remote computing devices. Such databases may store various user data, analytics, catalogs, and other information for natural language processing and/or other processing. In some implementations, such databases may be updated for adaptive learning and feedback for a neural network based on voice-input processing. In some cases, the utterance may include additional information, such as detected pauses (e.g., periods of non-speech) between words spoken by a user. The pauses may demarcate the locations of separate keywords or other information spoken by the user within the utterance.

After processing the voice input and determining an intent (e.g., via the keyword engine 471), the NMD 103 can perform an operation, which can include causing a user prompt to be displayed via one or more ACSs 101 participating in a communication session (FIG. 3). Referring back to FIG. 4, after performing the operation, the keyword engine 471 of the NMD 103 may resume or continue to monitor the sound-data stream S_{DS} until it spots another potential keyword, as discussed above.

In general, the one or more identification algorithms that a particular keyword engine applies are configured to analyze certain characteristics of the detected sound stream S_{DS} and compare those characteristics to corresponding characteristics of the particular keywords. For example, the keyword engine 471 may apply one or more identification algorithms to spot temporal and spectral characteristics in the detected sound stream S_{DS} that match the temporal and spectral characteristics of the engine's one or more keywords, and thereby determine that the detected sound S_{D} comprises a voice input including a particular keyword.

As noted above, the NMD 103 includes a keyword engine 471. The keyword engine 471 may apply one or more identification algorithms corresponding to one or more keywords. A “keyword event” is generated when a particular keyword is identified in the detected sound S_{D}. Under appropriate conditions, based on detecting one of these keywords, the NMD 103 determines or infers a user intent and performs the corresponding operation.

The keyword engine 471 can employ an automatic speech recognizer 472. The ASR 472 is configured to output phonetic or phonemic representations, such as text corresponding to words, based on sound in the sound-data stream S_{DS} to text. For instance, the ASR 472 may transcribe spoken words represented in the sound-data stream S_{DS} to one or more strings representing the voice input as text. The keyword engine 471 can feed ASR output (labeled as S_{ASR}) to a local natural language unit (NLU) 479 that identifies particular keywords as being keywords for invoking keyword events, as described below.

As noted above, in some example implementations, the NMD 103 is configured to perform natural language processing, which may be carried out using an onboard natural language understanding processor, referred to herein as a natural language unit (NLU) 479. The local NLU 479 is configured to analyze text output of the ASR 472 of the keyword engine 471 to spot (i.e., detect or identify) keywords in the voice input. In FIG. 4, this output is illustrated as the signal S_{ASR}. The local NLU 479 includes a library of keywords (i.e., words and/or phrases) corresponding to respective user intents and/or operations.

In one aspect, the library of the local NLU 479 includes keywords. When the local NLU 479 identifies a keyword in the signal S_{ASR}, the keyword engine 471 generates a keyword event and performs an operation corresponding to the keyword(s) in the signal S_{ASR}, assuming that one or more conditions corresponding to that keyword(s) are satisfied.

Some error in performing local automatic speech recognition is expected. Within examples, the ASR 472 may generate a confidence score when transcribing spoken words to text, which indicates how closely the spoken words in the voice input matches the sound patterns for that word. In some implementations, generating a keyword event is based on the confidence score for a given keyword. For instance, the keyword engine 471 may generate a keyword event when the confidence score for a given sound exceeds a given threshold value (e.g., 0.5 on a scale of 0-1, indicating that the given sound is more likely than not the keyword). Conversely, when the confidence score for a given sound is at or below the given threshold value, the keyword engine 471 does not generate the keyword event.

Similarly, some error in performing keyword matching is expected. Within examples, the local NLU may generate a confidence score when determining an intent, which indicates how closely the transcribed words in the signal S_{ASR} match the corresponding keywords in the library of the local NLU. In some implementations, performing an operation according to a determined intent is based on the confidence score for keywords matched in the signal S_{ASR}. For instance, the NMD 103 may perform an operation according to a determined intent when the confidence score for a given sound exceeds a given threshold value (e.g., 0.5 on a scale of 0-1, indicating that the given sound is more likely than not the keyword). Conversely, when the confidence score for a given intent is at or below the given threshold value, the NMD 103 does not perform the operation according to the determined intent.

In some embodiments, keyword matching can be performed via NLUs of two or more different NMDs on a local network, and the results can be compared or otherwise combined to cross-check the results, thereby increasing confidence and reducing the rate of false positives. For example, a first NMD may identify a keyword in voice input with a first confidence score. A second NMD may separately perform keyword detection on the same voice input (either by separately capturing the same user speech or by receiving sound input data from the first NMD transmitted over the local area network). The second NMD may transmit the results of its keyword matching to the first NMD for comparison and evaluation. If, for example, the first and second NMD each identified the same keyword, a false positive is less likely. If, by contrast, the first and second NMD each identified a different keyword (or if one did not identify a keyword at all), then a false positive is more likely, and the first NMD may decline to take further action. In some embodiments, the identified keywords and/or any associated confidence scores can be compared between the two NMDs to make a final intent determination. In some embodiments, the respective NLUs of the first and second NMDs can be similarly or identically configured (e.g., having the same libraries of keywords), or optionally the NLUs can be configured differently (e.g., having different libraries of keywords). Although these examples are described with respect to two NMDs, this comparison can be extended to three, four, five, or more different NMDs.

In some embodiments, such cross-checking can be performed not between two different NMDs, but between different sound data streams S_{DS} obtained via a single NMD 103. For example, the NMD 103 can be configured to generate a first sound-data stream S_{DS} representing data obtained from a first subset of the microphones 222, and to generate a second sound-data stream S_{DS} representing data obtained from a second subset of the microphones 222 that is different from the first. In an NMD having six microphones 222, the first sound-data stream S_{DS} may be generated using data from microphones 1-3, while the second sound-data stream S_{DS} may be generated using data from microphones 4-6. Optionally, in some embodiments the subsets of the microphones can include some overlapping microphones—for example the first sound-data stream S_{DS} can include data from microphones 1-4 and the second sound data stream can include data from microphones 3-6. Additionally, in some embodiments there may be three, four, five, or more different sound-data streams S_{DS} generated using different subsets of microphones or other variations in processing of voice input. Optionally, in some instances a sound-data stream S_{DS} can include input from individual microphones of different NMDs, for example combining inputs from two microphones of a first NMD and two microphones of a second NMD. However generated, these different sound-data streams S_{DS} can then be separately evaluated by the keyword engine 471 and the results can be compared or otherwise combined. For example, the NMD 103 may perform an action if and only if each of the local NLU 479 identifies the same keyword(s) in each of the evaluated sound-data streams S_{DS}.

As noted above, in some implementations, a phrase may be used as a keyword, which provides additional syllables to match (or not match). For instance, the phrase “play me some music” has more syllables than “play,” which provides additional sound patterns to match to words. Accordingly, keywords that are phrases may generally be less prone to false wake word triggers.

The NMD 103 includes the one or more state machine(s) 475 to facilitate determining whether the appropriate conditions are met. The state machine 475 transitions between a first state and a second state based on whether one or more conditions corresponding to the detected keyword are met. In particular, for a given keyword corresponding to a particular operation requiring one or more particular conditions, the state machine 475 transitions into a first state when one or more particular conditions are satisfied and transitions into a second state when at least one condition of the one or more particular conditions is not satisfied.

Within example implementations, the operation conditions are based on states indicated in state variables. As noted above, the devices of the ACSs may store state variables describing the state of the respective device. For instance, the NMD 103 may store state variables indicating the state of the NMDs 103, such as whether the microphones are currently enabled, and the like. These state variables are updated (e.g., periodically, or based on an event (i.e., when a state in a state variable changes)) and the state variables further can be shared among the devices participating in the communications session, including the NMD 103.

Similarly, the NMD 103 may maintain these state variables (either by virtue of being implemented in a playback device or as a stand-alone NMD). The state machine 475 monitors the states indicated in these state variables, and determines whether the states indicated in the appropriate state variables indicate that the operating condition(s) are satisfied. Based on these determinations, the state machine 475 transitions between the first state and the second state, as described above.

In some implementations, the keyword engine 471 may be disabled unless certain conditions have been met via the state machines, and/or the available keywords to be identified by the keyword engine can be limited based on conditions as reflected via the state machines. As one example, the first state and the second state of the state machine 475 may operate as enable/disable toggles to the keyword engine 471. In particular, while a state machine 475 corresponding to a particular keyword is in the first state, the state machine 475 enables the keyword engine 471 of the particular keyword. Conversely, while the state machine 475 corresponding to the particular keyword is in the second state, the state machine 475 disables the keyword engine 471 of the particular keyword. Accordingly, the disabled keyword engine 471 ceases analyzing the sound-data stream S_{DS}. In such cases when at least one condition is not satisfied, the NMD 103 may suppress generation of keyword event when the keyword engine 471 detects a keyword. Suppressing generation may involve gating, blocking or otherwise preventing output from the keyword engine 471 from generating the keyword event. Alternatively, suppressing generation may involve the NMD 103 ceasing to feed the sound data stream S_{DS} to the ASR 472. Such suppression prevents an operation corresponding to the detected keyword from being performed when at least one condition is not satisfied. In such embodiments, the keyword engine 471 may continue analyzing the sound data stream S_{DS} while the state machine 475 is in the first state, but keyword events are disabled.

Other example conditions may be based on the output of a voice activity detector (“VAD”) 465. The VAD 465 is configured to detect the presence (or lack thereof) of voice activity in the sound-data stream S_{DS}. The VAD 465 may utilize any suitable voice activity detection algorithms. Example voice detection algorithms involve determining whether a given frame includes one or more features or qualities that correspond to voice activity, and further determining whether those features or qualities diverge from noise to a given extent (e.g., if a value exceeds a threshold for a given frame). Some example voice detection algorithms involve filtering or otherwise reducing noise in the frames prior to identifying the features or qualities.

In some examples, the VAD 465 may determine whether voice activity is present in the environment based on one or more metrics. For example, the VAD 465 can be configured to distinguish between frames that include voice activity and frames that don't include voice activity. The frames that the VAD determines have voice activity may be caused by speech regardless of whether it is near- or far-field. In this example and others, the VAD 465 may determine a count of frames in the pre-roll portion of the voice input that indicate voice activity. If this count exceeds a threshold percentage or number of frames, the VAD 465 may be configured to output a signal or set a state variable indicating that voice activity is present in the environment. Other metrics may be used as well in addition to, or as an alternative to, such a count.

The presence of voice activity in an environment may indicate that a voice input is being directed to the NMD 103. Accordingly, when the VAD 465 indicates that voice activity is not present in the environment (perhaps as indicated by a state variable set by the VAD 465) this may be configured as one of the conditions for the keywords. When this condition is met (e.g., the VAD 465 indicates that voice activity is present in the environment), the state machine 475 will transition to the first state to enable performing operations based on keywords, so long as any other conditions for a particular keyword are satisfied.

Further, in some implementations, the NMD 103 may include a noise classifier 466. The noise classifier 466 is configured to determine sound metadata (frequency response, signal levels, etc.) and identify signatures in the sound metadata corresponding to various noise sources. The noise classifier 466 may include a neural network or other mathematical model configured to identify different types of noise in detected sound data or metadata. One classification of noise may be speech (e.g., far-field speech). Another classification may be a specific type of speech, such as background speech. Background speech may be differentiated from other types of voice-like activity, such as more general voice activity (e.g., cadence, pauses, or other characteristics) of voice-like activity detected by the VAD 465.

For example, analyzing the sound metadata can include comparing one or more features of the sound metadata with known noise reference values or a sample population data with known noise. For example, any features of the sound metadata such as signal levels, frequency response spectra, etc. can be compared with noise reference values or values collected and averaged over a sample population. In some examples, analyzing the sound metadata includes projecting the frequency response spectrum onto an eigenspace corresponding to aggregated frequency response spectra from a population of NMDs. Further, projecting the frequency response spectrum onto an eigenspace can be performed as a pre-processing step to facilitate downstream classification.

In various embodiments, any number of different techniques for classification of noise using the sound metadata can be used, for example machine learning using decision trees, or Bayesian classifiers, neural networks, or any other classification techniques. Alternatively or additionally, various clustering techniques may be used, for example K-Means clustering, mean-shift clustering, expectation-maximization clustering, or any other suitable clustering technique. Techniques to classify noise may include one or more techniques disclosed in U.S. Pat. No. 10,602,268 issued Mar. 24, 2020, and titled “Optimization of Network Microphone Devices Using Noise Classification,” which is herein incorporated by reference in its entirety.

In some implementations, the additional buffer 469 (shown in dashed lines) may store information (e.g., metadata or the like) regarding the detected sound S_{D} that was processed by the upstream AEC 463 and spatial processor 464. This additional buffer 469 may be referred to as a “sound metadata buffer.” Examples of such sound metadata include: (1) frequency response data, (2) echo return loss enhancement measures, (3) voice direction measures; (4) arbitration statistics; and/or (5) speech spectral data. In example implementations, the noise classifier 466 may analyze the sound metadata in the buffer 469 to classify noise in the detected sound S_{D}.

As noted above, one classification of sound may be background speech, such as speech indicative of far-field speech and/or speech indicative of a conversation not involving the NMD 103. The noise classifier 466 may output a signal and/or set a state variable indicating that background speech is present in the environment. The presence of such voice activity (i.e., speech) may indicate conversational speech within the environment that is not directed at the NMD 103. Further, when the noise classifier indicates that background speech is present in the environment, this condition may disable the keyword engine 471. In some implementations, the condition of background speech being absent in the environment (perhaps as indicated by a state variable set by the noise classifier 466) is configured as one of the conditions for the keywords. Accordingly, the state machine 475 will not transition to the first state when the noise classifier 466 indicates that background speech is present in the environment.

Further, the noise classifier 466 may determine whether background speech is present in the environment based on one or more metrics. For example, the noise classifier 466 may determine a count of frames in the pre-roll portion of the voice input that indicate background speech. If this count exceeds a threshold percentage or number of frames, the noise classifier 466 may be configured to output the signal or set the state variable indicating that background speech is present in the environment. Other metrics may be used as well in addition to, or as an alternative to, such a count.

Within example implementations, the NMD 103 may support a plurality of keywords. To facilitate such support, the keyword engine 471 may implement multiple identification algorithms corresponding to respective keywords. Alternatively, the NMD 103 may implement additional keyword engines configured to identify respective keywords. Yet further, the library of the local NLU 479 may include a plurality of keywords and be configured to search for text patterns corresponding to these keywords in the signal S_{ASR}.

Referring still to FIG. 4, in example embodiments, the keyword engine 471 may take a variety of forms. For example, the keyword engine 471 may take the form of one or more modules that are stored in memory of the NMD 103. As another example, the keyword engine 471 may take the form of a general-purpose or special-purpose processor, or modules thereof. Other possibilities also exist.

To further reduce false positives, the keyword engine 471 may utilize a relative low sensitivity. In practice, a keyword engine may include a sensitivity level setting that is modifiable. The sensitivity level may define a degree of similarity between a word identified in the detected sound stream S_{DS} and the keyword engine's one or more particular keywords words that is considered to be a match (i.e., that triggers a keyword event). In other words, the sensitivity level defines how closely, as one example, the spectral characteristics in the detected sound stream S_{DS} must match the spectral characteristics of the engine's one or more keywords. In this respect, the sensitivity level generally controls how many false positives that the keyword engine 471 identifies.

In practice, a sensitivity level may take a variety of forms. In example implementations, a sensitivity level takes the form of a confidence threshold that defines a minimum confidence (i.e., probability) level for a keyword engine that serves as a dividing line between triggering or not triggering a keyword event when the keyword engine is analyzing detected sound for its particular keywords. In this regard, a higher sensitivity level corresponds to a lower confidence threshold (and more false positives), whereas a lower sensitivity level corresponds to a higher confidence threshold (and fewer false positives). For example, lowering a keyword engine's confidence threshold configures it to trigger a keyword event when it identifies words that have a lower likelihood that they are the actual particular keyword, whereas raising the confidence threshold configures the engine to trigger a keyword event when it identifies words that have a higher likelihood that they are an actual keyword. Within examples, a sensitivity level of the keyword engine 471 may be based on more or more confidence scores, such as the confidence score in spotting a keyword and/or a confidence score in determining an intent. Other examples of sensitivity levels are also possible.

In example implementations, sensitivity level parameters (e.g., the range of sensitivities) for a particular keyword engine can be updated, which may occur in a variety of manners. As one possibility, the sensitive level parameters of the keyword engine 471 may be configured by the manufacturer of the NMD 103 or by another cloud service. In some examples, the library of the local NLU 479 is partially customized to the individual user(s).

### V. Example Intent Inference in Audio Communications Sessions

As noted above, in audiovisual communication sessions involving multiple ACSs 101, voice input can be analyzed (e.g., via an NMD of one or more of the ACSs 101) to infer an intent. Based on the inferred intent and, optionally, certain contextual features of the communication session, the ACS 101 (and/or its NMD 103) can then automatically cause user prompts to be presented to one or more participants to improve the user experience. For example, a user prompt can take the form of a graphical user interface allowing a user to select or decline a certain proposed operation, such as muting or unmuting a microphone, initiating sharing of a screen or other content, initiate or terminate recording of the session, or perform any other operation associated with the communication session.

FIG. 5 is a flow diagram showing an example method 500 for inferring user intent and causing a corresponding operation to be performed during an audiovisual communication session. The method 500 may be performed by an ACS 101 and/or an NMD 103 as described previously.

At block 501, the method 500 involves monitoring voice input for keyword(s) or other utterances during a communication session. For example, during a videoconference or other such communication session, one or more NMDs associated with the communication session can monitor the voice input (e.g., the voice input captured by that particular NMD and/or voice input transmitted to that NMD for audio playback during the communication session). As described above, monitoring the voice input can take the form of keyword spotting using a keyword engine, local NLU, or any other suitable voice processing techniques that can identify words, phrases, or other aspects of the voice input.

At block 503, the method 500 involves monitoring the context of the communication session. For example, the context can include the status of one or more devices associated with the session. Examples of context parameters that can be monitored include whether microphones are muted or unmuted, whether a screen or other content is being shared, whether a user is a host or non-host participant, whether a camera is active or inactive, whether the session is being recorded, or any other variable that may be relevant to the particular operation to be taken in response to the voice input.

At decision block 505, the method 500 includes determining whether the keywords identified in block 501 indicate a particular intent. If no user intent is inferred or otherwise identified, the method returns to block 501 to resume monitoring the voice input for keyword(s). If, in block 505, a particular intent is identified, then the method proceeds to block 507. In one example, intent can be inferred or determined using a lookup table that includes particular keywords or combinations of keywords and corresponding user intent. For example, detecting the keywords “share” and “screen” with some proximity to one another (e.g., within 5 seconds) can correspond to a user intent to share a screen. Similarly, the keywords “mute” and “mic” or “microphone” can correspond to a user intent to toggle a microphone setting (e.g., to mute or unmute a microphone). These limited examples are illustrative only, and one of skill in the art will appreciate that the concept of identifying one or more keywords and inferring an intent based on those keyword(s) can be applied to a wide range of keywords and a wide range of applicable user intents. In various embodiments, detection of keywords can include identifying a time between the keywords, a particular order of the keywords, or a number of times particular keywords have been detected within a given window (e.g., if the word “noise” is detected multiple times within a short duration, it is more likely that a user's microphone should be disabled to reduce noise for other participants). Additionally or alternatively, the voice input can be evaluated to identify a sentiment associated with one or more keywords or with the voice input in general—for example excitement, anger, or calm. The sentiment or valence of the voice input can likewise be associated with a particular intent, whether considered alone or in combination with one or more detected keywords.

At block 507, the method 500 involves causing a prompt to be displayed to one or more users according to the identified intent and the context parameters. The prompt can take the form of a graphical user interface that allows a user to provide input in response. For example, a message can be displayed on a display device asking whether a certain action should be performed (e.g., “mute microphone?”) along with user-selectable options (e.g., “yes” and “no” buttons).

Optionally, at block 509, the method 500 includes disappearing the prompt after user action or after a predetermined time period. For example, once a user selects “yes,” “no,” or other such response to the user prompt, the prompt can be disappeared from the display, the accompanying action can be performed (e.g., muting a user's microphone), and the communication session can continue uninterrupted. If a user takes no action, for example ignoring a prompt altogether, then the prompt may be disappeared (e.g., dismissed, disregarded, or otherwise caused to disappear from view) after a predetermined period of time, for example 10 seconds, 30 seconds, etc. In some instances, the prompt can include an option that allows a user to provide feedback or otherwise adjust settings associated with the intent inference. For example, the user may select a button or otherwise provide input such as “do not show this prompt again,” “I'm seeing this prompt too frequently,” or “do not show this prompt for at least 30 minutes.” In the example of a prompt asking whether a user wishes to mute her microphone, such responses by the user may be fed back to the NMD, which can modify thresholds for determining intent, for detecting keywords, or otherwise for surfacing that particular user prompt to that particular user.

In various embodiments, an NMD's intent inference can evolve and improve over time, for example by adapting the keyword engine and/or intent inference. Such adaptation can be performed in response to feedback received via that particular ACS, for example when a user continually declines to share her screen, the NMD may adapt to no longer prompt a user to share her screen, notwithstanding the detection of keywords such as “share” and “screen” within proximity to one another. Moreover, the NMD can adapt over time to a particular user or set of users, such as by adapting to a user's speech patterns, accent, particular vocabulary, etc. Additionally or alternatively, such adaptation can be performed in response to feedback received via a plurality of different ACSs, whether those ACSs are part of the same communication session or not. For example, as each ACS adaptively improves its keyword engine and/or its intent inference based on detected keywords and/or contextual parameters, these improvements can be sent to remote computing devices (e.g., CPP 303 of FIG. 3), where the improvements of individual ACSs can be aggregated or otherwise combined to create an improved algorithm for the keyword detection, intent inference, or user prompt generation operations of the ACS. Such improved algorithm(s) may then be transmitted from the remote computing devices (e.g., CPP 303 of FIG. 3) to individual ACSs in the form of software or firmware updates.

FIGS. 6A-7C illustrate two example scenarios in which a plurality of ACSs involved in a communication session perform operations based on detected voice input and certain context parameters. In each example, the environment includes four users, each associated with a particular ACS (not shown) having a display device (shown as Users 1-4 associated with Display Devices 1-4, respectively). The ACSs and their constituent display devices are communicatively coupled via network(s) 301, as described previously herein.

In the configuration shown in FIG. 6A, the four Users 1-4 are participating in an audiovisual communication session (e.g., a videoconference). User 2 has a muted microphone, and Users 1, 3, and 4 each have unmuted microphones. As User 4's dog barks, the rest of the users can hear the attendant noise. User 1 speaks, saying “I'm hearing a lot of noise.” This voice input can be captured via the NMD associated with User 1's ACS and processed to detect an utterance including one or more keywords. In this example, the NMD may identify the keywords “hearing” and “noise,” and optionally may also identify a temporal proximity between them (e.g., that “noise” was detected within a predetermined time period of detecting “hearing”).

In response to this voice input, as shown in FIG. 6B, user prompts can be displayed to Users 3 and 4 via their respective Display Devices. Here, because User 1 is the one who spoke the phrase “I'm hearing a lot of noise,” and because User 2's microphone is already muted, the user prompts are presented only to User 3 and User 4. As shown, the user prompts can take the form of a graphical user interface asking whether the user wishes to mute his device, with “yes” and “no” options. In this example, User 4 selects “yes,” perhaps realizing that his dog is barking, and his microphone is unmuted, while User 3 either selects “no” or takes no action, resulting in User 3's microphone remaining unmuted.

In this example, User 3, who is the source of the noise, is automatically prompted to mute his microphone without requiring intentional or explicit intervention by any person. Rather, simply by processing the voice input and monitoring context parameters (e.g., microphone status of each user), the appropriate user prompt can be surfaced automatically, and the communication experience can be improved for all participants.

In another example, certain context parameters can prevent the surfacing of the prompt to mute User 3's microphone. For example, if the ACS determines that User 3 is speaking (e.g., detecting that User 3's lips are moving, and/or detecting that User 3 is gazing toward the imaging device) then the system may determine that User 3 is intending to participate in the communication session and as such should not be prompted to mute her microphone. In alternative examples, context parameters can include an indication that a particular user is speaking to someone else (e.g., a second person is detected in the field of view), in which case it may be appropriate to prompt the user to mute her microphone. Various other such context parameters derived from image analysis can be used to cause appropriate user prompts to be surfaced throughout a communications session.

FIGS. 7A-7C illustrate another example of automatically prompting a user to perform an operation via the ACS in response to processing voice input and monitoring context parameters. In the arrangement shown in FIG. 7A, User 1 speaks the phrase “Are we recording this session?” An NMD (either associated with the ACS of User 1, or alternatively an NMD associated with any one of the other ACSs associated with Users 2, 3, or 4) processes the voice input and detects the keyword “recording.” Based on this identification, and in view of the context parameter that the communication session is not currently being recorded and that User 1 is the host, a user prompt is displayed to User 1 via Display Device 1, as shown in FIG. 7B, which asks whether User 1 wishes to start recording the session. In response to User 1 selecting “yes” in the user prompt, recording begins, and optionally all the users are identified via notifications shown via their respective display devices, as illustrated in FIG. 7C.

In another example, a user can be prompted to share her screen in response to an NMD detecting the words “share” and “screen” or “my screen” within a given interval of time. In the context of real-time entertainment with audience participation (e.g. livestreaming gaming or other content), a host may utter a phrase such as “don't forget to donate and subscribe to my channel.” In response, the NMD can receive and analyze this voice input and detect the keywords “donate” and “subscribe,” and, in response, surface a prompt to users (i.e., audience members) prompting the users to donate to the host or to subscribe to the host's channel. These limited examples are illustrative only, and there are innumerable possible user prompts or other operations that may be performed in response to detecting keywords in voice input and monitoring context parameters of a communication session.

Although several examples herein refer to communication session such as a video-chat or other such session, aspects of the present technology can be applied to other circumstances and environments. For example, within a single environment having multiple devices (at least one of which is an ACS 101), a voice input detected via one device may cause a user prompt to be presented via a separate ACS 101. For example, when a first user in a living room says out loud “what's for dinner?,” this phrase may be detected as audio input via a nearby NMD 103. This audio input can be processed and, based on keyword detection and certain context parameters (e.g., a context parameter indicating that a second user has opened a refrigerator door in the kitchen), an ACS can provide a suitable output. For example, an ACS 101 can take the form of a touchscreen and speaker integrated into a smart refrigerator device, and the user prompt can include proposed recipes or meal suggestions output via the speaker or touchscreen. Various additional details regarding voice-interactions that span multiple rooms or other spaces within an environment can be found in co-owned U.S. Application No. 16,502,617, filed May 3, 2019, titled VOICE ASSISTANT PERSISTENCE ACROSS MULTIPLE NETWORK MICROPHONE DEVICES, which is hereby incorporated by reference in its entirety.

Accordingly, there are numerous advantages to providing user prompts to participants in a communications session based on analyzing voice input and context parameters. The various aspects of inferring user intent and providing appropriate prompts described in the different examples above can be combined, modified, re-ordered, or otherwise altered to achieve the desired implementation.

### CONCLUSION

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the forgoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

The present technology is illustrated, for example, according to various aspects described below. Various examples of aspects of the present technology are described as numbered examples (1, 2, 3, etc.) for convenience. These are provided as examples and do not limit the present technology. It is noted that any of the dependent examples may be combined in any combination, and placed into a respective independent example. The other examples can be presented in a similar manner.

Example 1. A method, comprising: capturing voice input via one or more microphones of a network microphone device; transmitting the voice input to one or more remote computing devices for a communication session; analyzing the voice input to detect one or more utterances; and based on the one or more utterances, causing a user prompt to be displayed via a display device communicatively coupled to the network microphone device.

Example 2. The method of any one of the preceding Examples, further comprising: determining an intent based on the one or more detected utterances; and based at least in part on the intent, causing the user prompt to be displayed via the display device.

Example 3. The method of any one of the preceding Examples, wherein the communication session comprises a videoconference.

Example 4. The method of any one of the preceding Examples, wherein the display device is integrated with the network microphone device.

Example 5. The method of any one of the preceding Examples, wherein the display device is associated with a second user participating in the communications session.

Example 6. The method of any one of the preceding Examples, wherein analyzing the voice input to detect one or more utterances comprises analyzing the voice input via a local natural language processing unit configured to detect keywords in the voice input.

Example 7. The method of any one of the preceding Examples, wherein analyzing the voice input to detect one or more utterances comprises detecting two or more keywords within the voice input, the two or more keywords being detected within a predetermined time interval between them.

Example 8. The method of any one of the preceding Examples, wherein analyzing the voice input to detect one or more utterances comprises analyzing the voice input locally via the network microphone device, and wherein causing the user prompt to be displayed via the display device comprises transmitting a control signal based on results of the local analysis to one or more remote computing devices which cause the user prompt to be displayed via the display device.

Example 9. The method of any one of the preceding Examples, wherein the user prompt comprises one or more of: a prompt to mute or unmute a user's microphone; a prompt to share or un-share a user's screen; or a prompt to enable or disable a user's camera.

Example 10. The method of any one of the preceding Examples, further comprising monitoring a context parameter of the communication session and, based at least in part on the detected one or more voice utterances and the context parameter, causing the user prompt to be displayed via the display device.

Example 11. The method of any one of the preceding Examples, wherein the context parameter comprises one or more of: a microphone state of one or more users participating in the communications session; a screen share state of one or more users participating in the communications session; or a recording status of the communications session.

Example 12. The method of any one of the preceding Examples, further comprising concurrently with causing the prompt to be displayed via the display device, causing a different prompt to be displayed via a different display device.

Example 13. The method of any one of the preceding Examples, wherein the communication session involves a plurality of users each having a respective display device, the method further comprising causing the prompt to be displayed to some but not all of the display devices.

Example 14. The method of any one of the preceding Examples, further comprising causing the user prompt to be disappeared after a predetermined time if no user input is received in response to the prompt.

Example 15. A network microphone device comprising: one or more microphones; a network interface; one or more processors; and data storage having instructions stored therein that, when executed by the one or more processors, cause the network microphone device to perform operations comprising the method of any one of the preceding Examples.

Example 16. A tangible, non-transitory computer-readable medium storing instructions that, when executed by one or more processors of a network microphone device, cause the network microphone device to perform operations comprising the method of any one of the preceding Examples.

1. A system comprising:
a network microphone device having one or more microphones configured to capture voice input from a first user during a communication session involving at least the first user and a plurality of other users;
one or more processors; and
data storage having instructions stored therein that, when executed by the one or more processors, cause the system to:
analyze the voice input to detect keywords;
monitor a plurality of context parameters associated with each of the plurality of other users, wherein the context parameters comprise device status, user role, and participation level;
determine which subset of the plurality of other users should receive a prompt based on the detected keywords and the monitored context parameters;
generate customized prompts for each user in the determined subset based on their respective context parameters; and
cause the customized prompts to be selectively displayed via respective display devices associated with the determined subset of users.

2. The system of claim 1, wherein the device status comprises one or more of:
a microphone state indicating whether a user's microphone is muted or unmuted;
a screen share state indicating whether a user's screen is currently being shared; or
a camera state indicating whether a user's camera is active or inactive.

3. The system of claim 1, wherein the user role comprises one or more of:
host status indicating whether a user has host privileges in the communication session; or
participant status indicating whether a user is a regular participant without host privileges.

4. The system of claim 1, wherein the participation level comprises one or more of:
an indication of whether a user is actively speaking; an indication of whether a user is present in a field of view of an imaging device; or
an indication of user engagement based on image analysis of the user's behavior.

5. The system of claim 1, wherein determining which subset of the plurality of other users should receive a prompt comprises excluding users whose context parameters indicate they should not receive the prompt, and wherein the excluding is based on one or more of:
excluding users whose microphones are already muted when the detected keywords relate to muting; or
excluding host users when the detected keywords relate to operations restricted to non-host participants.

6. The system of claim 1, wherein generating customized prompts comprises creating different prompt content for different users based on their respective device status, such that users with unmuted microphones receive prompts asking whether to mute their microphones, while users with muted microphones receive prompts asking whether to unmute their microphones.

7. The system of claim 1, wherein the communication session comprises a videoconference, and wherein causing the customized prompts to be selectively displayed comprises transmitting control signals to a communications platform provider, which in turn causes the customized prompts to be displayed via the respective display devices of the determined subset of users.

8. A method comprising:
capturing voice input from a first user via one or more microphones of a network microphone device during a communication session involving at least the first user and a plurality of other users;
analyzing the voice input to detect keywords;
monitoring a plurality of context parameters associated with each of the plurality of other users, wherein the context parameters comprise device status, user role, and participation level;
determining which subset of the plurality of other users should receive a prompt based on the detected keywords and the monitored context parameters;
generating customized prompts for each user in the determined subset based on their respective context parameters; and
causing the customized prompts to be selectively displayed via respective display devices associated with the determined subset of users.

9. The method of claim 8, wherein the device status comprises one or more of:
a microphone state indicating whether a user's microphone is muted or unmuted;
a screen share state indicating whether a user's screen is currently being shared; or
a camera state indicating whether a user's camera is active or inactive.

10. The method of claim 8, wherein the user role comprises one or more of:
host status indicating whether a user has host privileges in the communication session; or
participant status indicating whether a user is a regular participant without host privileges.

11. The method of claim 8, wherein the participation level comprises one or more of:
an indication of whether a user is actively speaking; an indication of whether a user is present in a field of view of an imaging device; or
an indication of user engagement based on image analysis of the user's behavior.

12. The method of claim 8, wherein determining which subset of the plurality of other users should receive a prompt comprises excluding users whose context parameters indicate they should not receive the prompt, and wherein the excluding is based on one or more of:
excluding users whose microphones are already muted when the detected keywords relate to muting; or
excluding host users when the detected keywords relate to operations restricted to non-host participants.

13. The method of claim 8, wherein generating customized prompts comprises creating different prompt content for different users based on their respective device status, such that users with unmuted microphones receive prompts asking whether to mute their microphones, while users with muted microphones receive prompts asking whether to unmute their microphones.

14. The method of claim 8, wherein the communication session comprises a videoconference, and wherein causing the customized prompts to be selectively displayed comprises transmitting control signals to a communications platform provider, which in turn causes the customized prompts to be displayed via the respective display devices of the determined subset of users.

15. A tangible, non-transitory computer-readable medium storing instructions that, when executed by one or more processors of a network microphone device, cause the network microphone device to perform operations comprising:
capturing voice input from a first user via one or more microphones of the network microphone device during a communication session involving at least the first user and a plurality of other users;
analyzing the voice input to detect keywords;
monitoring a plurality of context parameters associated with each of the plurality of other users, wherein the context parameters comprise device status, user role, and participation level;
determining which subset of the plurality of other users should receive a prompt based on the detected keywords and the monitored context parameters;
generating customized prompts for each user in the determined subset based on their respective context parameters; and
causing the customized prompts to be selectively displayed via respective display devices associated with the determined subset of users.

16. The tangible, non-transitory computer-readable medium of claim 15,
wherein the device status comprises one or more of:
a microphone state indicating whether a user's microphone is muted or unmuted;
a screen share state indicating whether a user's screen is currently being shared; or
a camera state indicating whether a user's camera is active or inactive.

17. The tangible, non-transitory computer-readable medium of claim 15,
wherein the user role comprises one or more of:
host status indicating whether a user has host privileges in the communication session; or
participant status indicating whether a user is a regular participant without host privileges.

18. The tangible, non-transitory computer-readable medium of claim 15,
wherein the participation level comprises one or more of:
an indication of whether a user is actively speaking; an indication of whether a user is present in a field of view of an imaging device; or
an indication of user engagement based on image analysis of the user's behavior.

19. The tangible, non-transitory computer-readable medium of claim 15, wherein determining which subset of the plurality of other users should receive a prompt comprises excluding users whose context parameters indicate they should not receive the prompt, and wherein the excluding is based on one or more of:
excluding users whose microphones are already muted when the detected keywords relate to muting; or
excluding host users when the detected keywords relate to operations restricted to non-host participants.

20. The tangible, non-transitory computer-readable medium of claim 15, wherein generating customized prompts comprises creating different prompt content for different users based on their respective device status, such that users with unmuted microphones receive prompts asking whether to mute their microphones, while users with muted microphones receive prompts asking whether to unmute their microphones.
